(19) United States
(12) Patent Application Publication
(10) Pub. No.: US 2009/0307618 A1
(43) Pub. Date: Dec. 10, 2009

(54) ANNOTATE AT MULTIPLE LEVELS

(75) Inventors: Stephen L. Lawler, Redmond, WA (US); Blaise Aguera y Arcas, Seattle, WA (US); Brett D. Brewer, Sammamish, WA (US); Anthony T. Chor, Bellevue, WA (US); Steven Drucker, Bellevue, WA (US); Karim Farouki, Seattle, WA (US); Gary W. Flake, Bellevue, WA (US); Ariel J. Lazier, Seattle, WA (US); Donald James Lindsay, Mountain View, CA (US); Richard Stephen Szeliski, Bellevue, WA (US); Michael Fredrick Cohen, Seattle, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/133,765

(22) Filed: Jun. 5, 2008

(51) Int. Cl. G06F 3/048

(52) U.S. Cl. 715/764

(57) ABSTRACT

The claimed subject matter provides a system and/or a method that facilitates interacting with a portion of data that includes pyramidal volumes of data. A portion of image data can represent a computer displayable multi-scale image with at least two substantially parallel planes of view in which a first plane and a second plane are alternatively displayable based upon a level of zoom and which are related by a pyramidal volume, wherein the multi-scale image includes a pixel at a vertex of the pyramidal volume. An annotation component can determine a set of annotations associated with at least one of the two substantially parallel planes of view. A display engine can display at least a subset of the set of annotations on the multi-scale image based upon navigation to the parallel plane of view associated with the set of annotations.

### CROSS REFERENCE TO RELATED APPLICATION(S)

This application relates to U.S. patent application Ser. No. 11/606,554 filed on Nov. 30, 2006, entitled “RENDERING DOCUMENT VIEWS WITH SUPPLEMENTAL INFORMATIONAL CONTENT.” This application also relates to U.S. patent application Ser. No. 12/062,294 filed on Apr. 3, 2008, entitled “ZOOM FOR ANNOTATABLE MARGINS.” The entireties of the aforementioned applications are incorporated herein by reference.

### BACKGROUND

Conventionally, browsing experiences related to web pages or other web-displayed content are comprised of images or other visual components of a fixed spatial scale, generally based upon settings associated with an output display screen resolution and/or the amount of screen real estate allocated to a viewing application, e.g., the size of a browser that is displayed on the screen to the user. In other words, displayed data is typically constrained to a finite or restricted space correlating to a display component (e.g., monitor, LCD, etc.).

In general, the presentation and organization of data (e.g., the Internet, local data, remote data, websites, etc.) directly influences one's browsing experience and can affect whether such experience is enjoyable or not. For instance, a website with data aesthetically placed and organized tends to have increased traffic in comparison to a website with data chaotically or randomly displayed. Moreover, interaction capabilities with data can influence a browsing experience. For example, typical browsing or viewing data is dependent upon a defined rigid space and real estate (e.g., a display screen) with limited interaction such as selecting, clicking, scrolling, and the like.

While web pages or other web-displayed content have created clever ways to attract a user's attention even with limited amounts of screen real estate, there exists a rational limit to how much information can be supplied by a finite display space—yet, a typical user usually necessitates a much greater amount of information be provided to the user. Additionally, a typical user prefers efficient use of such limited display real estate. For instance, most users maximize browsing experiences by resizing and moving windows within display space.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate revealing or exposing annotations respective to particular locations on specific view levels on viewable data. A display engine can further enable seamless panning and/or zooming on a portion of data (e.g., viewable data) and annotations can be associated to such navigated locations. A display engine can employ enhanced browsing features (e.g., seamless panning and zooming, etc.) to reveal disparate portions or details of viewable data (e.g., web pages, documents, etc.) which, in turn, allows viewable data to have virtually limitless amount of real estate for data display. An annotation component can determine a set of annotations related to a particular location or view level. Viewable data can be zoomed out in to provide a different view of the original content such that certain aspects are highlighted while other aspects are presented in low resolution or detail. Moreover, viewable data can be zoomed in to reveal additional detail regarding aspect previously overlooked or presented in low resolution. Accordingly, as detail and resolution of aspects of the viewable data changes relative to navigation, the annotation component can establish a set of annotations on the viewable data optimal for a current view level or view location. In another example, a view level of the viewable data can correlate to the amount or context of annotations. For example, a zoom out to a specific level can expose specific annotations corresponding to the view level and respective displayed data (e.g., zoom out from map of a city can expose a map of a state as well as annotations or notes for that state, a zoom in to a city block can reveal annotations for that block, etc.).

Furthermore, the annotation component can provide a real time overlay of annotation or notes onto viewable data at certain zoom levels. Thus, at a first view level may not reveal annotations, whereas a second view level may reveal annotations. In other aspects of the claimed subject matter, methods are provided that facilitate providing a real time overlay of annotation or notes onto viewable data at certain zoom levels.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates revealing a portion of annotation data related to image data based on a view level or scale.

FIG. 2 illustrates a block diagram of an exemplary system that facilitates a conceptual understanding of image data including a multi-scale image.

FIG. 3 illustrates a block diagram of an exemplary system that facilitates dynamically and seamlessly navigating viewable or annotatable data in which annotations can be exposed based at least in part upon view level.

FIG. 4 illustrates a block diagram of an exemplary system that facilitates employing a zoom on viewable data in order to reveal annotative data onto viewable data respective to a view level.

FIG. 5 illustrates a block diagram of exemplary system that facilitates enhancing implementation of annotative techniques described herein with a display technique, a browse technique, and/or a virtual environment technique.

FIG. 6 illustrates a block diagram of an exemplary system that facilitates revealing a portion of annotation data related to image data based on a view level or scale.

FIG. 7 illustrates an exemplary methodology for revealing annotations related to a portion of viewable data based at least in part on a view level associated therewith.

FIG. 8 illustrates an exemplary methodology that facilitates exposing a portion of annotation data based upon a navigated view level.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “engine,” “annotation,” “network,” “structure,” “detailer,” “generator,” “aggregator,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It is to be appreciated that the subject innovation can be utilized with at least one of a display engine, a browsing engine, a content aggregator, and/or any suitable combination thereof. A “display engine” can refer to a resource (e.g., hardware, software, and/or any combination thereof) that enables seamless panning and/or zooming within an environment in multiple scales, resolutions, and/or levels of detail, wherein detail can be related to a number of pixels dedicated to a particular object or feature that carry unique information. In accordance therewith, the term “resolution” is generally intended to mean a number of pixels assigned to an object, detail, or feature of a displayed image and/or a number of pixels displayed using unique logical image data. Thus, conventional forms of changing resolution that merely assign more or fewer pixels to the same amount of image data can be readily distinguished. Moreover, the display engine can create space volume within the environment based on zooming out from a perspective view or reduce space volume within the environment based on zooming in from a perspective view. Furthermore, a “browsing engine” can refer to a resource (e.g., hardware, software, and/or any suitable combination thereof) that employs seamless panning and/or zooming at multiple scales with various resolutions for data associated with an environment, wherein the environment is at least one of the Internet, a network, a server, a website, a web page, and/or a portion of the Internet (e.g., data, audio, video, text, image, etc.). Additionally, a “content aggregator” can collect two-dimensional data (e.g., media data, images, video, photographs, metadata, etc.) to create a three dimensional (3D) virtual environment that can be explored (e.g., browsing, viewing, and/or roaming such content and each perspective of the collected content).

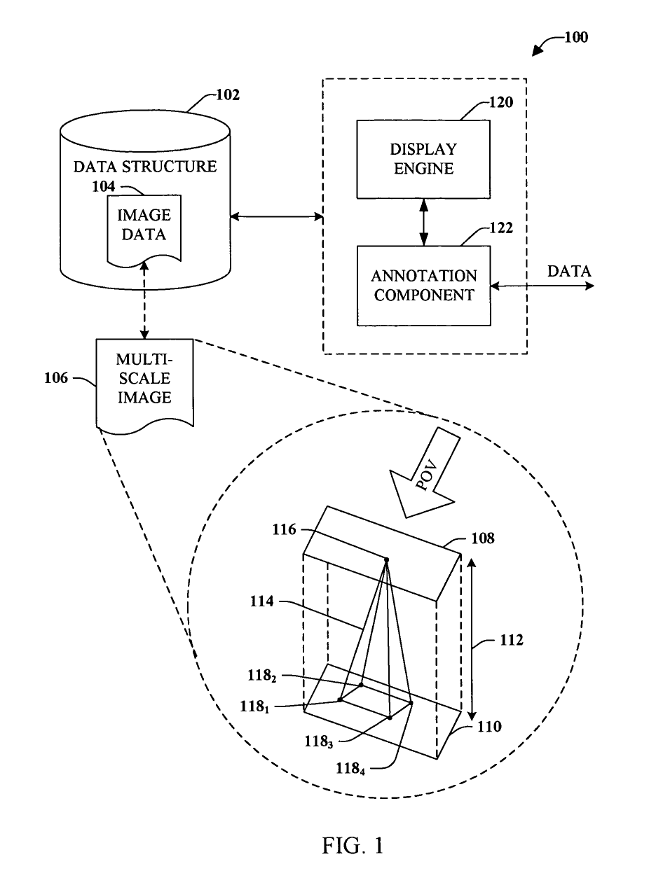

Now turning to the figures, FIG. 1 illustrates a system 100 that facilitates revealing a portion of annotation data related to image data based on a view level or scale. Generally, system 100 can include a data structure 102 with image data 104 that can represent, define, and/or characterize computer displayable multi-scale image 106, wherein a display engine 120 can access and/or interact with at least one of the data structure 102 or the image data 104 (e.g., the image data 104 can be any suitable data that is viewable, displayable, and/or be annotatable). In particular, image data 104 can include two or more substantially parallel planes of view (e.g., layers, scales, etc.) that can be alternatively displayable, as encoded in image data 104 of data structure 102. For example, image 106 can include first plane 108 and second plane 110, as well as virtually any number of additional planes of view, any of which can be displayable and/or viewed based upon a level of zoom 112. For instance, planes 108, 110 can each include content, such as on the upper surfaces that can be viewable in an orthographic fashion. At a higher level of zoom 112, first plane 108 can be viewable, while at a lower level zoom 112 at least a portion of second plane 110 can replace on an output device what was previously viewable.

Moreover, planes 108, 110, et al., can be related by pyramidal volume 114 such that, e.g., any given pixel in first plane 108 can be related to four particular pixels in second plane 110. It should be appreciated that the indicated drawing is merely exemplary, as first plane 108 need not necessarily be the top-most plane (e.g., that which is viewable at the highest level of zoom 112), and, likewise, second plane 110 need not necessarily be the bottom-most plane (e.g., that which is viewable at the lowest level of zoom 112). Moreover, it is further not strictly necessary that first plane 108 and second plane 110 be direct neighbors, as other planes of view (e.g., at interim levels of zoom 112) can exist in between, yet even in such cases the relationship defined by pyramidal volume 114 can still exist. For example, each pixel in one plane of view can be related to four pixels in the subsequent next lower plane of view, and to 116 pixels in the next subsequent plane of view, and so on. Accordingly, the number of pixels included in pyramidal volume at a given level of zoom, l, can be described as p=4^{l}, where l is an integer index of the planes of view and where l is greater than or equal to zero. It should be appreciated that p can be, in some cases, greater than a number of pixels allocated to image 106 (or a layer thereof) by a display device (not shown) such as when the display device allocates a relatively small number of pixels to image 106 with other content subsuming the remainder or when the limits of physical pixels available for the display device or a viewable area is reached. In these or other cases, p can be truncated or pixels described by p can become viewable by way of panning image 106 at a current level of zoom 112.

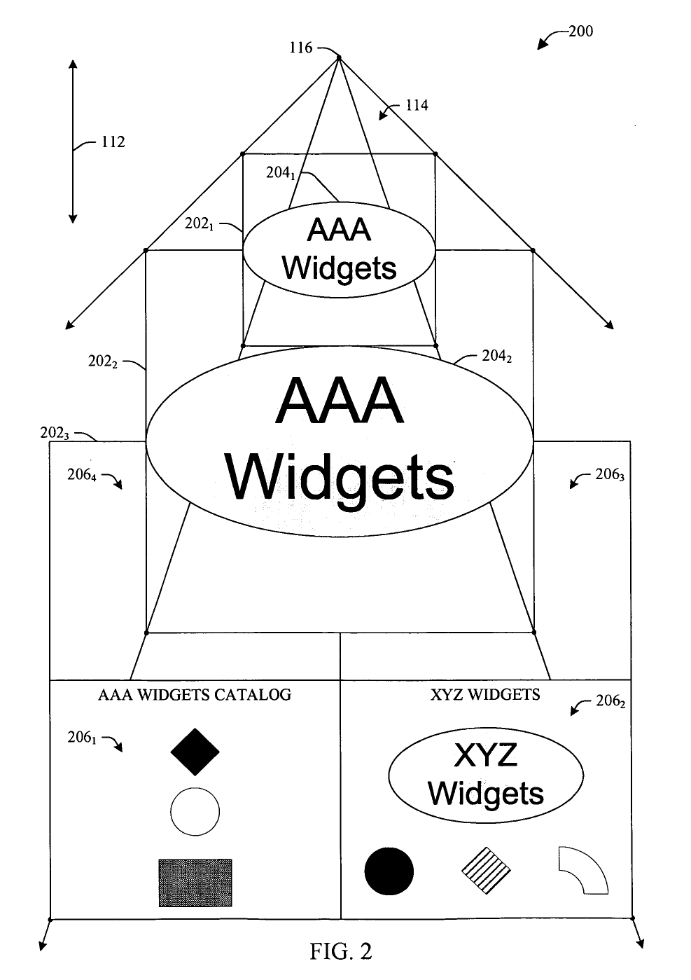

However, in order to provide a concrete illustration, first plane 108 can be thought of as a top-most plane of view (e.g., l=0) and second plane 110 can be thought of as the next sequential level of zoom 112 (e.g., l=1), while appreciating that other planes of view can exist below second plane 110, all of which can be related by pyramidal volume 114. Thus, a given pixel in first plane 108, say, pixel 116, can by way of a pyramidal projection be related to pixels 118₁-118₄ in second plane 110. The relationship between pixels included in pyramidal volume 114 can be such that content associated with pixels 118₁-118₄ can be dependent upon content associated with pixel 116 and/or vice versa. It should be appreciated that each pixel in first plane 108 can be associated with four unique pixels in second plane 110 such that an independent and unique pyramidal volume can exist for each pixel in first plane 108. All or portions of planes 108, 110 can be displayed by, e.g., a physical display device with a static number of physical pixels, e.g., the number of pixels a physical display device provides for the region of the display that displays image 106 and/or planes 108, 110. Thus, physical pixels allocated to one or more planes of view may not change with changing levels of zoom 112, however, in a logical or structural sense (e.g., data included in trade card 102 or image data 104) each success lower level of zoom 112 can include a plane of view with four times as many pixels as the previous plane of view, which is further detailed in connection with FIG. 2, described below.

The system 100 can further include an annotation component 122 determines a set of annotations to reveal based at least in part on a view level. The annotation component 122 can receive a portion of data (e.g., a portion of navigation data, etc.) in order to reveal a portion of annotation data related to viewable data (e.g., viewable object, displayable data, annotatable data, the data structure 102, the image data 104, the multi-scale image 106, etc.). The annotation component 122 can expose annotation data associated with a specific view level on the viewable data based at least upon context and/or navigation to such specific view level. In addition, the annotation component 122 can reveal annotation data based upon analysis of detail displayed relative to an specific location of the viewable data. In general, the display engine 120 can provide navigation (e.g., seamless panning, zooming, etc.) with viewable data (e.g., the data structure 102, the portion of image data 104, the multi-scale image 106, etc.) in which annotations can correspond to a location (e.g., a location within a view level, a view level, etc.) thereon.

For example, the system 100 can be utilized in viewing, displaying, editing, and/or creating annotation data at view levels on any suitable viewable data. In displaying and/or viewing annotations, based upon navigation and/or viewing location on the viewable data, respective annotations can be displayed and/or exposed. For example, a text document can be viewed in accordance with the subject innovation. At a first level view (e.g., a page layout view), annotations related to the general page layout can be viewed and/or exposed based upon such view level and the context of such annotations. At a second level view (e.g., a zoom in which a single paragraph is illustrated), annotations related to the zoomed paragraph can be exposed. In another example, the viewable data can be a portion of a multi-scaled image 106, wherein disparate view levels can include additional data, disparate data, etc. in which annotations can correspond to each view level. For instance, a map or atlas can be viewed in accordance with the subject innovation. At a first level view (e.g., a country view), annotations related to an entire country or nation can be revealed based upon such view level. At a second level view (e.g., a zoom in which a region or city of a country is depicted), annotations related to the zoomed region or city can be exposed.

Furthermore, the annotation component 122 can receive annotations to include with a portion of viewable data and/or edits related to annotations existent within viewable data. Viewable data can be accessed in order to include, associate, overlay, incorporate, embed, etc. an annotation thereto specific to a particular location. For example, a location can be a specific location on a particular view level to which the annotation relates or corresponds. In another example, the annotation can be more general relating to an entire view level on viewable data. For example, a first collection of annotations can correspond and reside on a first level of viewable data, whereas a second collection of annotations can correspond to a disparate level on the viewable data. Moreover, a location can be a specific location on a particular range of view levels. The range of view levels can be explicitly defined to a specific range. In addition the range can be implicitly established based upon detail of the specific location such that the annotation can be exposed when sufficient detail of the specific location is displayed to give context for the annotation.

The system 100 can enable a portion of viewable data to be annotated without disturbing or affecting the original layout and/or structure of such viewable data. For example, a portion of viewable data can be zoomed (e.g., zoom in, zoom out, etc.) which can trigger annotation data to be exposed. In other words, the original layout and/or structure of the viewable data is not disturbed based upon annotations being embedded and accepted at disparate view levels rather than the original default view of the viewable data. The system 100 can provide space (e.g., white space, etc.) and/or in situ margins that can accept annotations without obstructing the viewable data. Moreover, the system 100 can occlude the viewable data with annotations. For instance, the system 100 can cover a portion of viewable data with an annotation related to an adjacent portion to draw attention to the adjacent portion.

Furthermore, the display engine 120 and/or the annotation component 122 can enable transitions between view levels of data to be smooth and seamless. For example, transitioning from a first view level with particular annotations to a second view level with disparate annotations can be seamless and smooth in that annotations can be manipulated with a transitioning effect. For example, the transitioning effect can be a fade, a transparency effect, a color manipulation, blurry-to-sharp effect, sharp-to-blurry effect, growing effect, shrinking effect, etc.

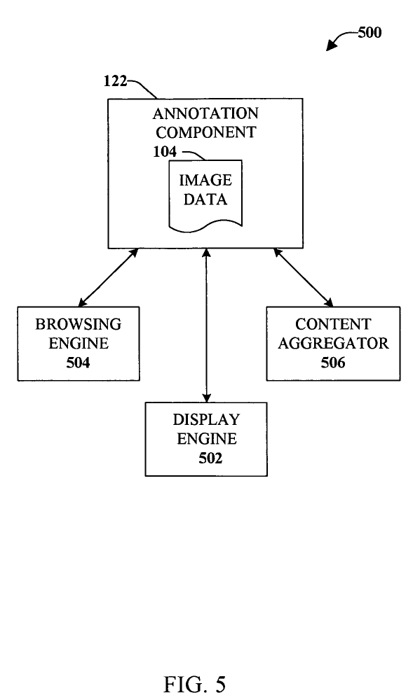

It is to be appreciated that the system 100 can enable a zoom within a 3-dimensional (3D) environment in which the annotation component 122 can reveal annotations associated to a portion of such 3D environment. In particular, a content aggregator (not shown but discussed in FIG. 5) can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). Thus, a virtual 3D environment can be explored by a user, wherein the environment is created from a group of 2D content. The annotation component 122 can expose an annotation linked to a location or navigated point in the 3D virtual environment. In other words, points in 3D space can be annotated with the system 100 wherein such annotations can be revealed in 3D space based upon navigation (e.g., a zoom in, a zoom out, etc.). In another example, the annotations may not be associated with a particular point or pixel within the 3D virtual environment, but rather an area of a computed 3D geometry. It is to be appreciated that the claimed subject matter can be applied to 2D environments (e.g., including a multi-scale mage having two or more substantially parallel planes in which a pixel can be expanded to create a pyramidal volume) and/or 3D environements (e.g., including 3D virtual environments created from 2D content with the content having a portion of content and a respective viewpoint).

Turning now to FIG. 2, example image 106 is illustrated to facilitate a conceptual understanding of image data including a multi-scale image. In this example, image 106 includes four planes of view, with each plane being represented by pixels that exist in pyramidal volume 114. For the sake of simplicity, each plane of view includes only pixels included in pyramidal volume 114; however, it should be appreciated that other pixels can also exist in any or all of the planes of view although such is not expressly depicted. For example, the top-most plane of view includes pixel 116, but it is readily apparent that other pixels can also exist as well. Likewise, although not expressly depicted, planes 202₁-202₃, which are intended to be sequential layers and to potentially exist at much lower levels of zoom 112 than pixel 116, can also include other pixels.

In general, planes 202₁-202₃ can represent space for annotation data. In this case, the image 106 can include data related to “AAA widgets” who fills space with the information that is essential thereto (e.g., company's familiar trademark, logo 204₁, etc.). At this particular level of zoom, an annotation related to “AAA widgets” can be embedded and/or associated therewith in which the annotation can be exposed during navigation to such view level. As the level of zoom 112 is lowered to plane 202₂, what is displayed in the space can be replaced by other data so that a different layer of image 106 can be displayed, in this case logo 204₂. In this level, for example, a disparate portion of annotation data related to the logo 204₂ can be embedded and/or utilized. In other words, each level of zoom or view level can include respective and corresponding annotation data which can be exposed upon navigation to each respective level. Moreover, annotation data can be incorporated into levels based on the context of such annotation such that annotations are revealed at levels where sufficient detail is present to provide context for annotation data. In an aspect of the claimed subject matter, one plane can display all or a portion another plane at a different scale, which is illustrated by planes 202₂, 202₁, respectively. In particular, plane 202₂ includes about four times the number of pixels as plane 202₁, yet associated logo 204₂ need not be merely a magnified version of logo 204₁ that provides no additional detail and can lead to “chucky” rendering, but rather can be displayed at a different scale with an attendant increase in the level of detail.

Additionally or alternatively, a lower plane of view can display content that is graphically or visually unrelated to a higher plane of view (and vice versa). For instance, as depicted by planes 202₂ and 202₃ respectively, the content can change from logo 204₂ to, e.g., content described by reference numerals 206₁-206₄. Thus, in this case, the next level of zoom 112 provides a product catalog associated with the AAA Widgets company and also provides advertising content for a competitor, “XYZ Widgets” in the region denoted by reference numeral 206₂. Other content can be provided as well in the regions denoted by reference numerals 206₃-206₄. It is to be appreciated that each region, level of zoom, or view level can include corresponding and respective annotation data, wherein such annotations are indicative or relate to the data on such level or region.

By way of further explanation consider the following holistic example. Pixel 116 is output to a user interface device and is thus visible to a user, perhaps in a portion of viewable content allocated to web space. As the user zooms (e.g., changes the level of zoom 112) into pixel 116, additional planes of view can be successively interpolated and resolved and can display increasing levels of detail with associated annotations. Eventually, the user zooms to plane 202₁ and other planes that depict more detail at a different scale, such as plane 202₂. However, a successive plane need not be only a visual interpolation and can instead include content that is visually or graphically unrelated such as plane 202₃. Upon zooming to plane 202₃, the user can peruse the content and/or annotations displayed, possibly zooming into the product catalog to reach lower levels of zoom relating to individual products and so forth.

Additionally or alternatively, it should be appreciated that logos 204₁, 204₂ can be a composite of many objects, say, images of products included in one or more product catalogs that are not discernible at higher levels of zoom 112, but become so when navigating to lower levels of zoom 112, which can provide a realistic and natural segue into the product catalog featured at 206₁, as well as, potentially that for XYZ Widgets included at 206₂. In accordance therewith, a top-most plane of view, say, that which includes pixel 116 need not appear as content, but rather can appear, e.g., as an aesthetically appealing work of art such as a landscape or portrait; or, less abstractly can relate to a particular domain such as a view of an industrial device related to widgets. Naturally countless other examples can exist, but it is readily apparent that pixel 116 can exist at, say, the stem of a flower in the landscape or at a widget depicted on the industrial device, and upon zooming into pixel 116 (or those pixels in relative proximity), logo 204₁ can become discernible.

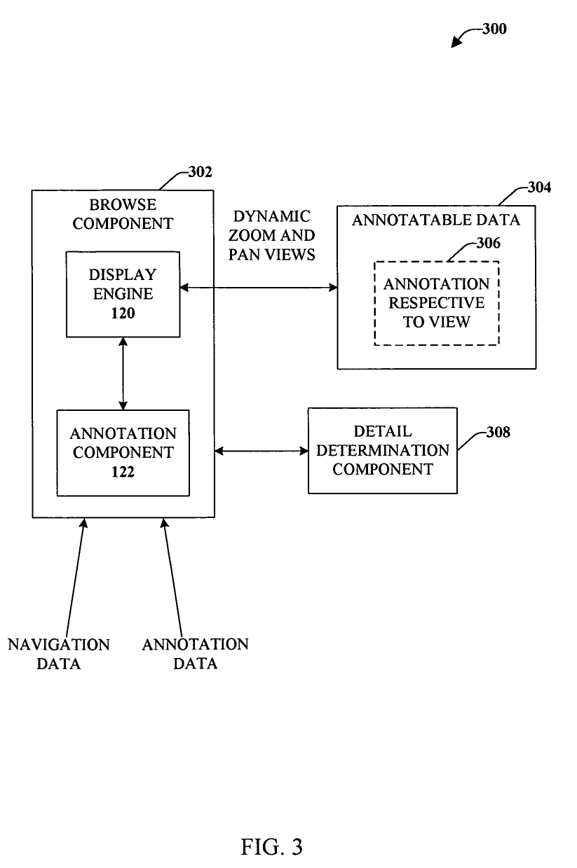

FIG. 3 illustrates a system 300 that facilitates dynamically and seamlessly navigating viewable or annotatable data in which annotations can be exposed based at least in part upon view level. The system 300 can include the display engine 120 that can interact with a portion of viewable data and/or annotatable data 304 to view annotations associated therewith. Furthermore, the system 300 can include the annotation component 122 that can select a set of annotation data, wherein such annotation data can be exposed on the viewable data. Such revelation can correspond to the view level of which the annotations relate. For example, a particular annotation can relate to a specific view level on viewable data in which such annotation will be displayed or exposed during navigation to such view level. For instance, the display engine 120 can allow seamless zooms, pans, and the like which can expose portions of annotation data respective to a view level 306 on annotatable data 304. For example, the annotatable data 304 can be any suitable viewable data such as a web page, a web site, a document, a portion of a graphic, a portion of text, a trade card, a portion of video, etc. Moreover, the annotation can be any suitable data that conveys annotations for such annotatable data such as, but not limited to, a portion of text, a portion of handwriting, a portion of a graphic, a portion of audio, a portion of video, etc.

The system 300 can further include a browse component 302 that can leverage the display engine 120 and/or the annotation component 122 in order to allow interaction or access with a portion of the annotatable data 304 across a network, server, the web, the Internet, cloud, and the like. The browse component 302 can receive at least one of annotation data (e.g., comments, notes, text, graphics, criticism, etc.) or navigation data (e.g., instructions related to navigation within data, view level location, location within a particular view level, etc.). Moreover, the annotatable data 304 can include at least one annotation respective to a view 306, wherein the browse component 302 can interact therewith. In other words, the browse component 302 can leverage the display engine 120 and/or the annotation component 122 to enable viewing or displaying annotation data corresponding to a navigated view level. For example, the browsing component 302 can receive navigation data that defines a particular location within annotatable data 304, wherein annotation data respective to view 306 can be displayed. It is to be appreciated that the browse component 302 can be any suitable data browsing component such as, but not limited to, a potion of software, a portion of hardware, a media device, a mobile communication device, a laptop, a browser application, a smartphone, a portable digital assistant (PDA), a media player, a gaming device, and the like.

The system 300 can further include a detail determination component 308. The detail determination component 308 can analyze detail displayed by the display engine 120 with respect to a specific location in the viewable or annotatable data 304. For example, viewable data with annotations already embedded therein in relation to a specific location and/or view level. In general, the system 300 can leverage the display engine 120 to seamlessly pan or zoom within the viewable data to provide more details on a particular location. The detail determination component 308 can evaluate the details on the particular location to determine if sufficient detail is presented to provide context for annotations associated with the particular location. Upon the determination that sufficient details are presented, the annotation component 122 can select annotations associated with the particular location for display in situ with the viewable or annotatable data 304.

In accordance with another example, the annotation component 122 can allow annotations to be associated with another annotation. In other words, an annotation embedded or incorporated to viewable data (e.g., on a particular location within a view level, associated with a general view level, etc.) can be annotated. Thus, a first annotation can be viewed and seamlessly panned or zoomed by the display engine 120, wherein a second annotation can correspond to a particular location within the first annotation.

The system 300 can further utilize various filters in order to organize and/or sort annotations associated with viewable data and respective view levels. For example, filters can be pre-defined, user-defined, and/or any suitable combination thereof. In general, a filter can limit or increase the number of annotations and related data (e.g., avatars, annotation source data, etc.), displayed based upon user preferences, default settings, relationships (e.g., within a network community, user-defined relationships, social network, contacts, address books, online communities, etc.), and/or geographic location. It is to be appreciated that any suitable filter can be utilized with the subject innovation with numerous criteria to limit or increase the exposure of annotations for viewable data and/or a view level related to viewable data and the stated examples above are not to be limiting on the subject innovation.

It is to be appreciated that the system 300 can be provided as at least one of a web service or a cloud (e.g., a collection of resources that can be accessed by a user, etc.). For example, the web service or cloud can receive an instruction related to exposing or revealing a portion of annotations based upon a particular location on viewable data. A user, for instance, can be viewing a portion of data and request exposure of annotations related thereto. A web service, a third-party, and/or a cloud service can provide such annotations based upon a navigated location (e.g., a particular view level, a location on a particular view level, etc.).

The annotation component 122 can further utilize a powder ski streamer component (not shown) that can indicate whether annotations exist if a zoom is performed on viewable data. For instance, it can be difficult to identify whether annotations exists with a zoom in on viewable data. If a user does not zoom in, annotations may not be seen or a user may not know how far to zoom to see annotations. The powder ski streamer component can be any suitable data that informs that annotations exist with a zoom. It is to be appreciated that the powder ski streamer component can be, but is not limited to, a graphic, a portion of video, an overlay, a pop-up window, a portion of audio, and/or any other suitable data that can display notifications to a user that annotations exist.

The powder ski streamer component can provide indications to a user based on their personal preferences. For example, a user's data browsing can be monitored to infer implicit interests and likes to which the powder ski streamer component can utilize to form a basis on whether to indicate or point out annotations. Moreover, relationships related to other users can be leveraged in order to point out annotations from such related users. For example, a user can be associated with a social network community with at least one friend who has annotated a document. While viewing such document, the powder ski streamer component can identify such annotation and provide indication to the user that such friend has annotated the document to which they are browsing and/or viewing. It is to be appreciated that the powder ski streamer component can leverage implicit interests (e.g., via data browsing, history, favorites, passive monitoring of web sites, purchases, social networks, address books, contacts, etc.) and/or explicit interests (e.g., via questionnaires, personal tastes, disclosed personal tastes, hobbies, interests, etc.).

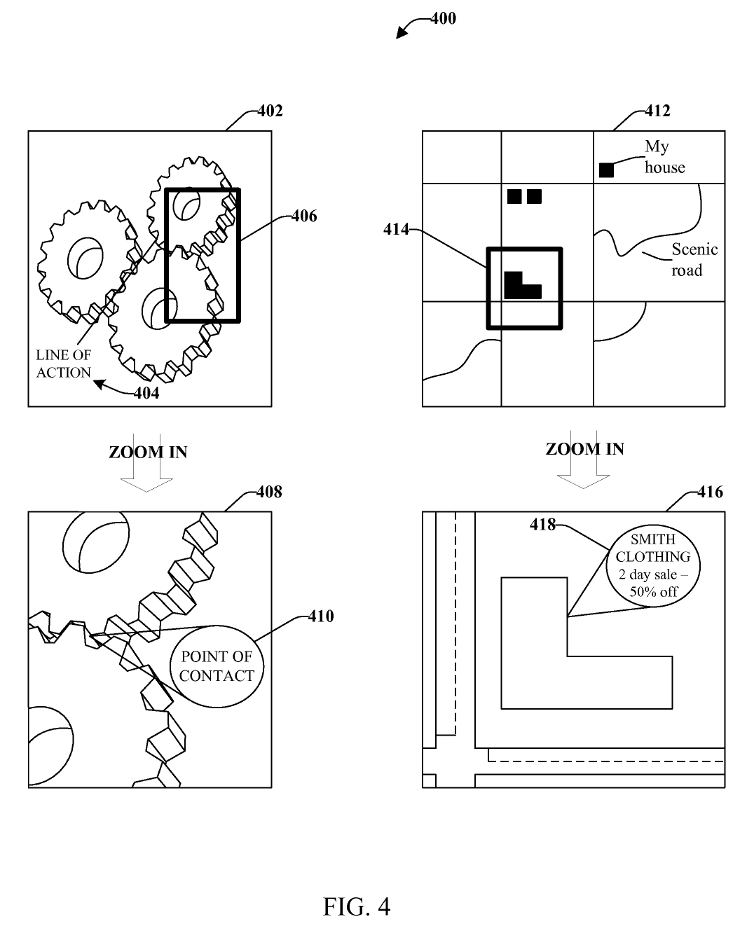

FIG. 4 illustrates a system 400 that facilitates employing a zoom on viewable data in order to populate annotative data onto viewable data respective to a view level. The system 400 illustrates utilizing seamless pans and/or zooms via a display engine (not shown) in order to reveal embedded or incorporated annotations. Such annotations can correspond to the specific location and view level navigated to with such panning and/or zooming. For example, panning to an upper right corner on viewable data and zooming in to a third view level can reveal specific annotations related to such area.

A portion of viewable data 402 is depicted as a graphic with three gears. It is to be appreciated that the viewable data 402 can be any suitable data that can be annotated such as, but not limited to, a data structure, image data, multi-scale image, text, web site, portion of graphic, portion of audio, portion of video, a trade card, a web page, a document, a file, etc. At a first view level that depicts the viewable data 402, an annotation 404 associated with that view level can be revealed. An area 406 is depicted as a viewing area that is going to be navigated to a specific location. A zoom in on the area 406 can provide a new view level 408 of the viewable data 402, wherein such view level can include an annotation 410 commenting on a feature associated with such view. At the first view level of the viewable data 402, sufficient details are presented to provide context for annotation 404 (e.g., the entirety of the gears are exposed thus enabling an annotation describing the line of action between the gears to be supported visually). At a disparate view level (e.g., zoom in view level 406), the annotation 410 can be displayed and/or exposed in place of annotation 404. At view level 406, sufficient detail or context is not provided to support annotation 404; however, annotation 410 describing the point of contact between gear teeth can be supported. Pursuant to another aspect, the point of contact is displayed at the first level, but not in sufficient detail to fully visualize the point. Accordingly, annotation 410 is not revealed until that detail is provided.

In another example, a portion of viewable data 412 is depicted as an image (e.g., map data, satellite imagery, etc.). In this particular example, the viewable data 412 includes an expansive view of the image. At the expansive view, a first set of annotations can be exposed (as illustrated with “My house” and “Scenic road,” etc.). An area 414 is depicted as a viewing area that is going to be navigated to a specific location. Thus, a zoom in can be performed to provide a second view level 416 on the viewable data 410 that corresponds to area 414. By zooming in, additional details related to area 414 are displayed. The additional details provide context for disparate annotations not displayed at a first view level. Thus, such zoom or navigation to area 414 can expose or reveal an annotation 418 related to the second view level 416.

The subject innovation can further utilize any suitable descriptive data for annotations related to a source of such annotation. In one example, tags can be associated with annotations that can indicate information of the source, wherein such information can be, but is not limited to, time, date, name, department, location, position, company information, business information, a website, a web page, contact information (e.g., phone number, email address, address, etc.), biographical information (e.g., education, graduation year, etc.), an availability status (e.g., busy, on vacation, etc.), etc. In another example, an avatar can be displayed which dynamically and graphically represents each user using, viewing, and/or editing/annotating the web page. The avatar can be incorporated into respective comments or annotations on the web page for identification.

FIG. 5 illustrates a system 500 that facilities enhancing implementation of annotative techniques described herein with a display technique, a browse technique, and/or a virtual environment technique. The system 500 can include the annotation component 122 and a portion of image data 104. The system 500 can further include a display engine 502 that enables seamless pan and/or zoom interaction with any suitable displayed data, wherein such data can include multiple scales or views and one or more resolutions associated therewith. In other words, the display engine 502 can manipulate an initial default view for displayed data by enabling zooming (e.g., zoom in, zoom out, etc.) and/or panning (e.g., pan up, pan down, pan right, pan left, etc.) in which such zoomed or panned views can include various resolution qualities. The display engine 502 enables visual information to be smoothly browsed regardless of the amount of data involved or bandwidth of a network. Moreover, the display engine 502 can be employed with any suitable display or screen (e.g., portable device, cellular device, monitor, plasma television, etc.). The display engine 502 can further provide at least one of the following benefits or enhancements: 1) speed of navigation can be independent of size or number of objects (e.g., data); 2) performance can depend on a ratio of bandwidth to pixels on a screen or display; 3) transitions between views can be smooth; and 4) scaling is near perfect and rapid for screens of any resolution.

For example, an image can be viewed at a default view with a specific resolution. Yet, the display engine 502 can allow the image to be zoomed and/or panned at multiple views or scales (in comparison to the default view) with various resolutions. Thus, a user can zoom in on a portion of the image to get a magnified view at an equal or higher resolution. By enabling the image to be zoomed and/or panned, the image can include virtually limitless space or volume that can be viewed or explored at various scales, levels, or views with each including one or more resolutions. In other words, an image can be viewed at a more granular level while maintaining resolution with smooth transitions independent of pan, zoom, etc. Moreover, a first view may not expose portions of information or data on the image until zoomed or panned upon with the display engine 502.

A browsing engine 504 can also be included with the system 500. The browsing engine 504 can leverage the display engine 502 to implement seamless and smooth panning and/or zooming for any suitable data browsed in connection with at least one of the Internet, a network, a server, a website, a web page, and the like. It is to be appreciated that the browsing engine 504 can be a stand-alone component, incorporated into a browser, utilized with in combination with a browser (e.g., legacy browser via patch or firmware update, software, hardware, etc.), and/or any suitable combination thereof. For example, the browsing engine 504 can be incorporate Internet browsing capabilities such as seamless panning and/or zooming to an existing browser. For example, the browsing engine 504 can leverage the display engine 502 in order to provide enhanced browsing with seamless zoom and/or pan on a website, wherein various scales or views can be exposed by smooth zooming and/or panning.

The system 500 can further include a content aggregator 506 that can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). For instance, the content aggregator 506 can aggregate a large collection of photos of a place or an object, analyze such photos for similarities, and display such photos in a reconstructed 3D space, depicting how each photo relates to the next. It is to be appreciated that the collected content can be from various locations (e.g., the Internet, local data, remote data, server, network, wirelessly collected data, etc.). For instance, large collections of content (e.g., gigabytes, etc.) can be accessed quickly (e.g., seconds, etc.) in order to view a scene from virtually any angle or perspective. In another example, the content aggregator 506 can identify substantially similar content and zoom in to enlarge and focus on a small detail. The content aggregator 506 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently viewed content; and 5) communicate a collection or a particular view of content to an entity (e.g., user, machine, device, component, etc.).

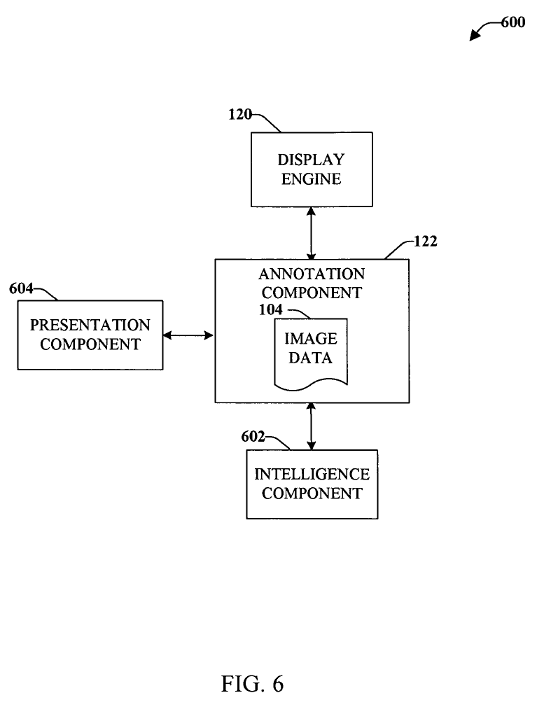

FIG. 6 illustrates a system 600 that employs intelligence to facilitate revealing a portion of annotation data related to image data based on a view level or scale. The system 600 can include the data structure (not shown), the image data 104, the annotation component 122, and the display engine 120. It is to be appreciated that the data structure (not shown), the image data 104, the edit component 122, and/or the display engine 120 can be substantially similar to respective data structures, image data, annotation components, and display engines described in previous figures. The system 600 further includes an intelligence component 602. The intelligence component 602 can be utilized by at least one of the annotation component 122 to facilitate selecting and/or displaying annotations corresponding to view levels, view details, specific locations, etc. For instance, the intelligence component 602 can infer whether a particular view level presents sufficient detail related to a specific location such that associated annotations are provided with context. Moreover, the intelligence component 602 can infer which portions of data to expose or reveal for a user based on a navigated location or layer within the image data 104. For instance, a first portion of data can be exposed to a first user navigating the image data and a second portion of data can be exposed to a second user navigating the image data. Such user-specific data exposure can be based on user settings (e.g., automatically identified, user-defined, inferred user preferences, etc.). Moreover, the intelligence component 602 can infer optimal publication or environment settings, display engine settings, security configurations, durations for data exposure, sources of the annotations, context of annotations, optimal form of annotations (e.g., video, handwriting, audio, etc.), and/or any other data related to the system 600.

The intelligent component 602 can employ value of information (VOI) computation in order to expose or reveal annotations for a particular user. For instance, by utilizing VOI computation, the most ideal and/or annotations can be identified and exposed for a specific user. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The system 600 can further utilize a presentation component 604 that provides various types of user interfaces to facilitate interaction with the annotation component 122. As depicted, the presentation component 604 is a separate entity that can be utilized with edit component 122. However, it is to be appreciated that the presentation component 604 and/or similar view components can be incorporated into the annotation component 122 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into at least one of the annotation component 122 or the display engine 120.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

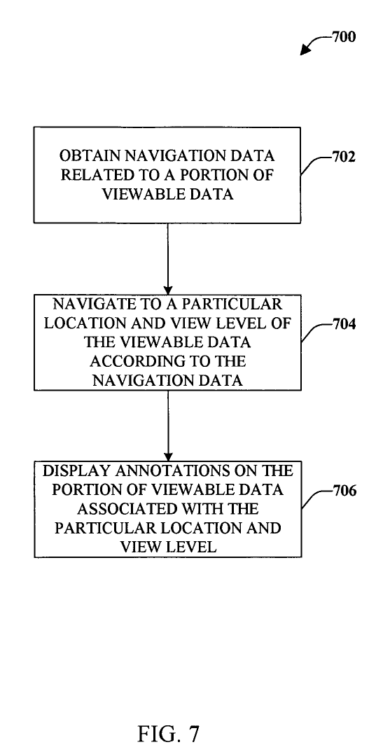

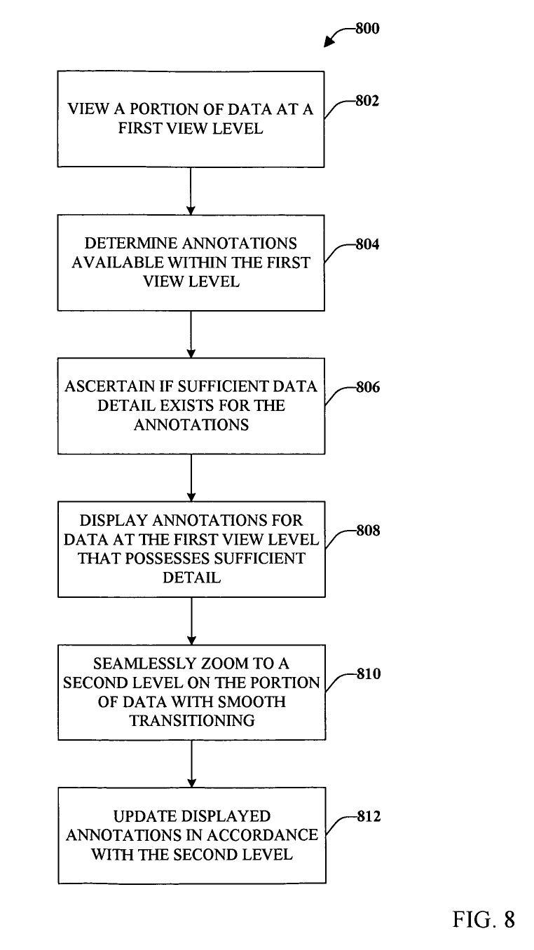

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates revealing annotation related to a portion of viewable data based at least in part on a view level associated therewith. At reference numeral 702, a portion of navigation data can be obtained. For example, the portion of navigation data can identify a location on viewable data and/or a view level on viewable data. It is to be appreciated that the viewable data can be, but is not limited to, a web page, a web site, a document, a portion of a graphic, a portion of text, a trade card, a portion of video, etc.

At reference numeral 704, a particular location and/or view level of the viewable data can be navigated to according to the obtained navigation data. In particular, the viewable data can include various layers, views, and/or scales associated therewith. Thus, viewable data can include a default view wherein a zooming in can dive into the data to deeper levels, layers, views, and/or scales. It is to be appreciated that diving (e.g., zooming into the data at a particular location) into the data can provide at least one of the default view on such location in a magnified depiction, exposure of additional data not previously displayed at such location, or active data revealed based on the deepness of the dive and/or the location of the origin of the dive. It is to be appreciated that once a zoom in on the viewable data is performed, a zoom out can also be employed which can provide additional data, de-magnified views, and/or any combination thereof.

At reference numeral 706, annotations on the portion of viewable data corresponding to the navigated location and/or view level can be displayed. Annotations can be any suitable data that conveys comments, explanations, remarks, observations, notes, clarifications, interpretations, etc. for the viewable data. The annotations can include a portion of text, a portion of handwriting, a portion of a graphic, a portion of audio, a portion of video, etc. Thus, a first dive from a first location with image A can expose a set of data and/or annotation data, whereas a zoom out back to the first location can display image A, another image, additional data, annotations, etc. Additionally, the data can be navigated with pans across a particular level, layer, scale, or view. Thus, a surface area of a level and be browsed with seamless pans.

Moreover, a set of annotations can be associated with a location and/or view level such that the set is revealed upon navigation. Thus, a first view level can reveal a first set of annotations and a second view level can reveal a second set of annotations. In general, the annotations can be embedded with the viewable data based upon the context, wherein the view level can correspond to the context of the annotations.

FIG. 8 illustrates a method 800 for facilitates exposing a portion of annotation data based upon a navigated view level. At reference numeral 802, a portion of data can be viewed at a first view level. At reference numeral 804, annotations available within the first view level are determined. For instance, annotations can be associated or linked with the first view level such that the annotations are exposed or revealed when the first view level is displayed. In addition, the first view level can include portions or objects therein that retain associated annotations such that the annotations can be exposed if sufficient details of the portions or objects are displayed. At reference numeral 806, it is ascertained if sufficient data detail exists for the available annotations. For example, an annotation can relate to a specific location of the portion of data that is at a low resolution or is otherwise presented in low detail. Thus, the annotation can confuse or misdirect since there is insufficient visual context. At reference numeral 808, available annotations associated with data that posses sufficient detail at the first view level are displayed. As annotations associated with data possessing insufficient detail can be confusing or misleading, such annotations are suppressed until navigation in the portion of data reveals sufficient detail.

At reference numeral 810, a second level on the portion of data can be seamlessly zoomed with smooth transitioning. For example, a transitioning effect can be applied to at least one annotation. The transitioning effect can be, but is not limited to, a fade, a transparency effect, a color manipulation, blurry-to-sharp effect, sharp-to-blurry effect, growing effect, shrinking effect, etc. At reference numeral 812, displayed annotations are updated in accordance with the second level. For example, additional annotations can be related to the second view level such that a set of available annotations is altered. Moreover, at the second view level, aspects presented in low detail can now be displayed in high detail. In addition, certain aspects can be occluded or otherwise hidden.

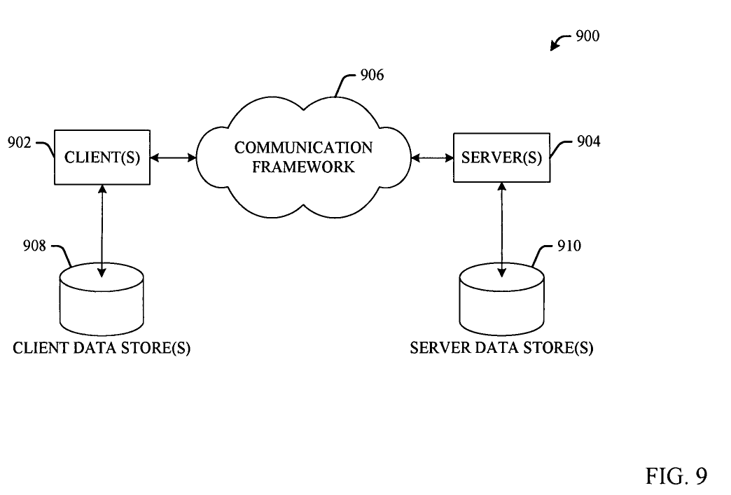

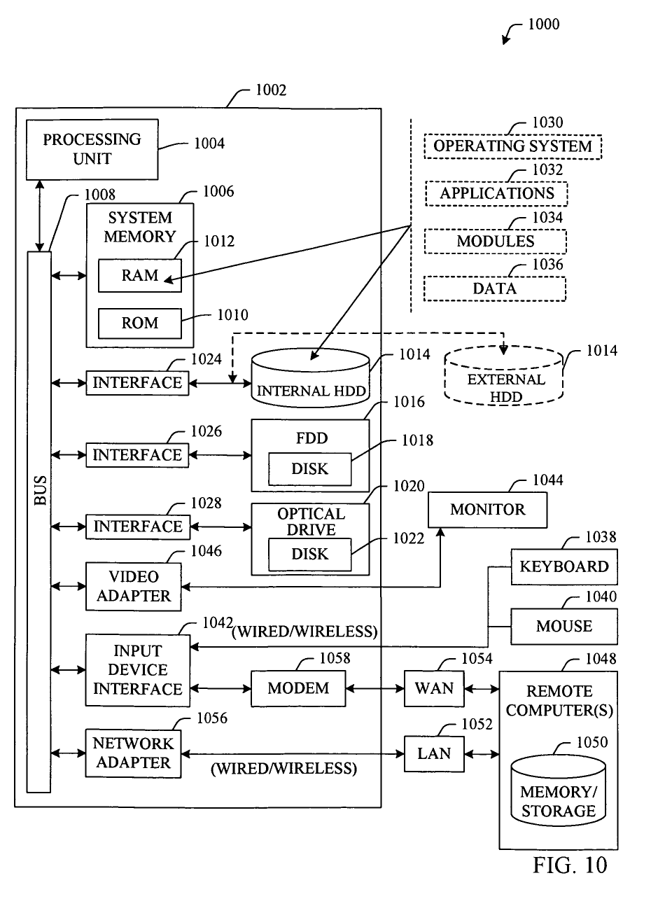

In order to provide additional context for implementing various aspects of the claimed subject matter, FIGS. 9-10 and the following discussion is intended to provide a brief, general description of a suitable computing environment in which the various aspects of the subject innovation may be implemented. For example, an annotation component can reveal annotations based on a navigated location or view level, as described in the previous figures, can be implemented or utilized in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer-implemented system that facilitates interacting with a portion of viewable data, comprising:
a portion of viewable data that represents a computer displayable multi-scale image with at least two substantially parallel planes of view are alternatively displayable
an annotation component that determines a set of annotations associated with at least one of the two substantially parallel planes of view; and
a display engine that displays at least a subset of the set of annotations on the multi-scale image based upon navigation to the parallel plane of view associated with the set of annotations.

2. The system of claim 1, the determined set of annotations includes annotations related to a portion of the multi-scale image depicted in the plane of view.

3. The system of claim 1, the set of annotations is at least one of portions of text, portions of handwriting, portions of graphics, portions of audio or portions of video.

4. The system of claim 1, further comprising a detail determination component that ascertains if a plane of view provides sufficient detail on a portion of the multi-scale image to support an associated annotation.

5. The system of claim 4, the annotation component selects the annotation when the detail determination component discovers sufficient detail is provided.

6. The system of claim 1, the at least two substantially parallel planes of view include a first plane and a second plane that are alternatively displayable based upon a zoom level, the first and second planes are related by a pyramidal volume and the multi-scale image includes a pixel at a vertex of the pyramidal volume.

7. The system of claim 6, the second plane of view displays a portion of the first plane of view at one of a different scale or a different resolution.

8. The system of claim 6, the second plane of view displays a portion of the multi-scale image that is graphically or visually unrelated to the first plane of view.

9. The system of claim 6, the annotation component determines a set of annotations associated with the second plane of view that is disparate to a set of annotations associated with the first plan of view.

10. The system of claim 1, image data representing the multi-scale image is a portion of viewable data that can be annotated, the portion of viewable data is associated with at least one of a web page, a web site, a document, a portion of a graphic, a portion of text, a trade card, or a portion of video.

11. The system of claim 1, further comprising a cloud that hosts at least one of the display engine, the annotation component, or the multi-scale image, wherein the cloud is at least one resource that is maintained by a party and accessible by an identified user over a network.

12. The system of claim 1, the display engine implements a seamless transition between annotations located on a plurality of planes of view, the seamless transition is provided by a transitioning effect that is at least one of a fade, a transparency effect, a color manipulation, a blurry-to-sharp effect, a sharp-to-blurry effect, a growing effect, or a shrinking effect.

13. The system of claim 1, further comprising a powder ski streamer component that indicates to a user whether an annotation exists if a zoom in is performed on the multi-scale image, the powder ski streamer is at least one of a graphic, a portion of video, an overlay, a pop-up window, or a portion of audio.

14. The system of claim 1, further comprising a filter that employs at least one of a limitation of an amount of annotations or an increase of an amount of annotations, the filter is based upon at least one of a user preference, a default setting, a relationship, a relationship within a network community, a user-defined relationship, a relationship within a social network, a contact, an affiliation with an address book, a relationship within an online community, or a geographic location.

15. The system of claim 1, the annotation includes descriptive data indicative of a source of the annotation, the descriptive data is at least one of an avatar, a tag, a portion of text, a website, a web page, a time, a date, a name, a department within a business, a location, a position within a company, a portion of contact information, a portion of biographical information, or an availability status.

16. A computer-implemented method that facilitates integrating data onto a portion of viewable data, comprising:
obtaining a portion of navigation data related to the portion of viewable data;
navigating to a location and view level of the portion of viewable data based at least in part on the obtained portion of navigation data; and
displaying annotations on the portion of viewable data that are associated with the navigated location and view level on the viewable data.

17. The method of claim 16, further comprising smoothly transitioning between a first annotation on a first view level on the viewable data and a second annotation on a second view level on the viewable data.

18. The method of claim 16, further comprising indicating to a user that an annotation exists on the viewable data if a zoom in is performed.

19. The method of claim 16, further comprising:
determining a set of available annotations that are associated with the portion of viewable data at the navigated location and view level;
evaluating the portion of viewable data to ascertain if sufficient detail exists to support each annotation in the set of available annotations; and
suppressing any annotations lacking sufficient detail.

20. A computer-implemented system that facilitates presenting annotated data within a computing environment, comprising:
means for representing a computer displayable multi-scale image with at least two substantially parallel planes of view in which a first plane and a second plane are alternatively displayable based upon a level of zoom and which are related by a pyramidal volume, the image includes a pixel at a vertex of the pyramidal volume;
means for navigating to a particular location and plane of view of the multi-scale image;
means for determining a set of available annotations associated with the particular location and plane of view;
means for analyzing the multi-scale image at the particular location and plane of view to ascertain if sufficient data is present to provide context for each annotation in the set of available annotations;
means for removing annotations from the set of annotations associated with data lacking sufficient context; and
means for displaying the set of annotations on the multi-scale image based.
